(19) United States
(12) Patent Application Publication
(10) Pub. No.: US 2026/0117821 A1
(43) Pub. Date: Apr. 30, 2026

(54) SLIDING RAIL ASSEMBLY WITH A HANDLE

(71) Applicant: Nan Juen International Co., Ltd., Taoyuan City (TW)

(72) Inventor: Fu-Tien CHANG, Taoyuan City (TW)

(21) Appl. No.: 19/366,562

(22) Filed: Oct. 23, 2025

(30) Foreign Application Priority Data
Oct. 30, 2024 (TW) 113141921

(51) Int. Cl. F16C 29/02

(52) U.S. Cl. CPC F16C 29/02

(57) ABSTRACT

A sliding rail assembly includes a first rail having a first surface and a second surface, a handle disposed on the first surface and having an actuating portion, and a clasp provided on the second surface. The clasp has a clasp portion and a coupling portion opposite to the clasp portion. The coupling portion is connected to the actuating portion. When the actuating portion is in a first state and drives the clasp toward a first position, the clasp portion is in the locked state; or when the actuating portion is in a second state and drives the clasp toward a second position, the clasp portion is in the unlocked state.

### BACKGROUND OF THE INVENTION

### Field of the Invention:

The present invention relates to a slide rail assembly with a handle, which is used to lock or unlock the slide rails.

### Description of the Related Art:

The server chassis and server rack are connected using a slide rail structure. For example, a first rail is provided on each side of the server chassis, and a second rail is provided on each side of the server rack relative to the respective first rail, and a locking device is provided between the first rail and the second rail. Using the server chassis handle to guide the locking device for unlocking is inconvenient. Furthermore, the heavy weight of the locking device creates lateral stress on the first rail, resulting in insufficient interference when locking the device, which can lead to locking failure.

### SUMMARY OF THE INVENTION

The main object of the present invention is to provide a slide rail assembly with a handle, which is independently located on the first rail for locking or unlocking, without relying on the handle of the server chassis for unlocking.

Another object of the present invention is to provide a slide rail assembly with a handle, wherein the handle and the clasp are positioned on different sides of the first rail, directly utilizing the shape of the first rail to position the handle and the clasp, eliminating the need for a locking device and thus avoiding lateral stress on the first rail.

Still another object of the invention is to provide a slide rail assembly with a handle, wherein the handle and the clasp are positioned on different sides of the first rail to form a first module, and the buckle is positioned on the second rail to form a second module. This allows the clasp portion of the clasp and the buckle to effectively coordinate and interfere with relative positions, thereby preventing locking or unlocking failures.

To achieve the above objects, the present invention adopts the technical means of slide rail assembly with a handle, which comprises: a first rail having a first surface and a second surface opposite to the first surface: a handle disposed on the first surface and having an actuating portion; and a clasp disposed on the second surface and having a clasp portion and a coupling portion opposite to the clasp portion, the coupling portion being connected to the actuating portion, wherein when the actuating portion is in a first state and drives the clasp toward a first position, the clasp portion is in a locked state; or when the actuating portion is in a second state and drives the clasp toward a second position, the clasp portion is in an unlocked state.

To achieve the above objects, the present invention adopts the technical means of slide rail assembly with a handle, which comprises a first rail having a first surface and a second surface opposite to the first surface: a handle disposed on the first surface and having an actuating portion; a clasp disposed on the second surface and having a clasp portion and a coupling portion opposite to the clasp portion, the coupling portion being connected to the actuating portion, wherein when the actuating portion is in a first state and drives the clasp toward a first position, the clasp portion is in a locked state, or when the actuating portion is in a second state and drives the clasp toward a second position, the clasp portion is in an unlocked state; and a second rail provided with a buckle, wherein when the actuating portion is in a first state and drives the clasp toward a first position, the clasp portion is locked on the buckle, resulting in a locked state; or when the actuating portion is in a second state and drives the clasp toward the second position, the clasp portion is released from the buckle, resulting in an unlocked state.

### BRIEF DESCRIPTION OF THE DRAWINGS

FIG. 1 is a three-dimensional exploded view of the present invention.

FIG. 2 is a three-dimensional diagram of the combination of the present invention.

FIG. 3 is a schematic diagram of the handle, clasp and first rail of the present invention.

FIG. 4A is a three-dimensional assembly view of the handle, clasp, and first rail combination of the present invention.

FIG. 4B is a three-dimensional assembly view of the handle, clasp, and first rail combination of the present invention viewing from another angle.

FIG. 5 is a schematic diagram of the present invention with the actuating portion in the first state and the clasp portion in the locked state.

FIG. 6 is a schematic diagram of the present invention in which the actuating portion is in the second state and the clasp portion is in the unlocked state.

FIG. 7 is an exploded view of the first rail and second rail of the present invention.

FIG. 8 is an assembled view of the first rail and second rail of the present invention.

FIG. 9 is an assembled view of the first rail and second rail of the present invention viewing from another angle.

FIG. 10 is a side view of the present invention showing the clasp portion being buckled in the buckle and in a locked state.

FIG. 11 is a schematic diagram of one side of the operating portion of the present invention via an operating force.

FIG. 12 is a schematic diagram of another side of the operating portion of the present invention via an operating force.

FIG. 13 is a side view schematic diagram of the present invention showing the clasp portion being detached from the buckle and in an unlocked state.

### DETAILED DESCRIPTION OF THE PREFERRED EMBODIMENT

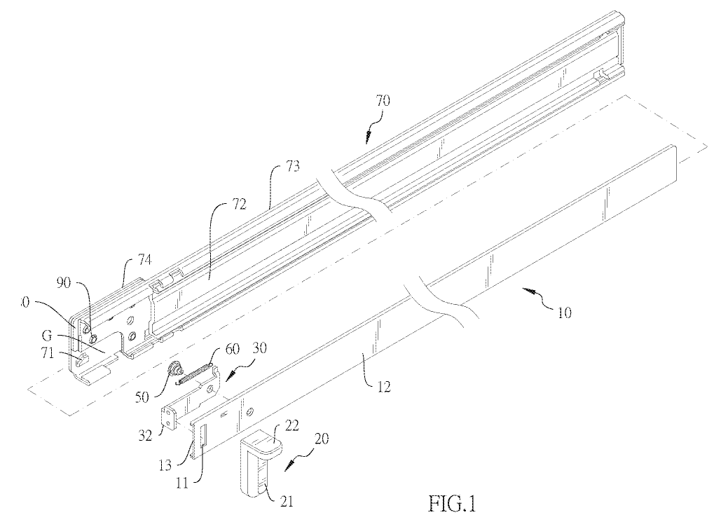

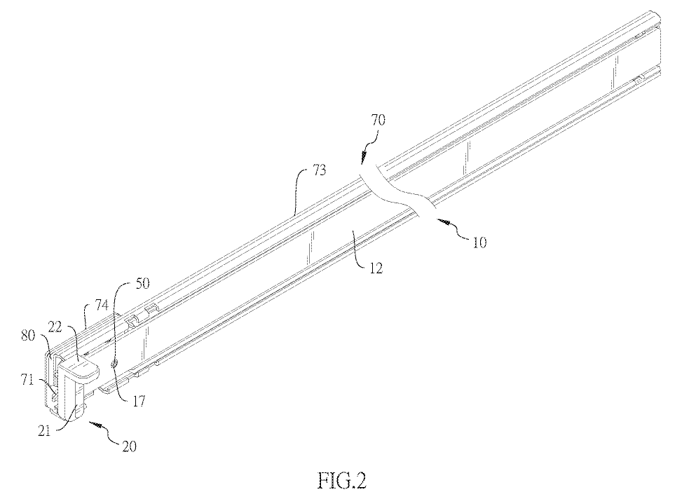

Please refer to FIGS. 1 to 6. The present invention is a slide rail assembly with a handle, comprising: a first rail 10 having a first surface 12 and a second surface 13 opposite to the first surface 12, a handle 20 provided on the first surface 12 and having an actuating portion 21, and a clasp 30 disposed on the second surface 13 and having a clasp portion 31 and a coupling portion 32 opposite to the clasp portion 31, wherein the coupling portion 32 is connected to the actuating portion 21.

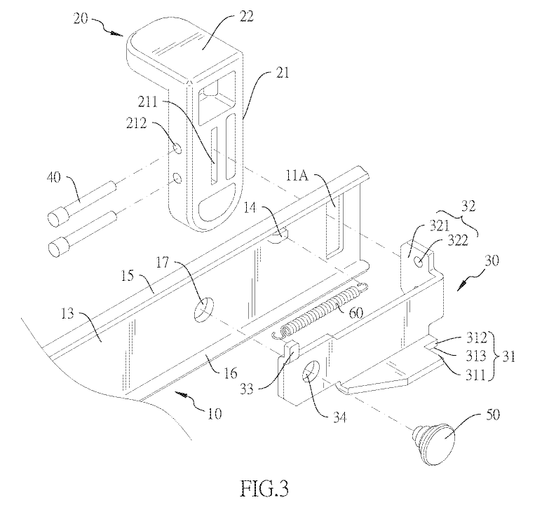

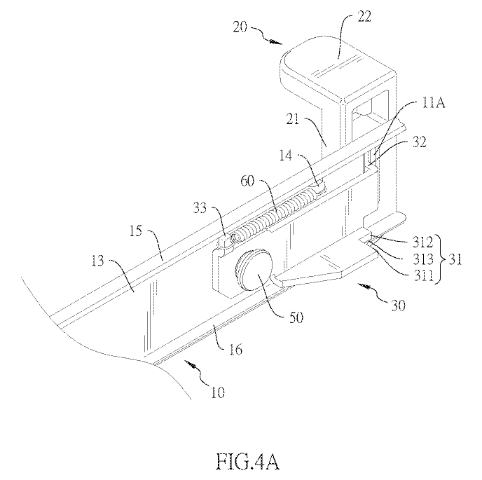

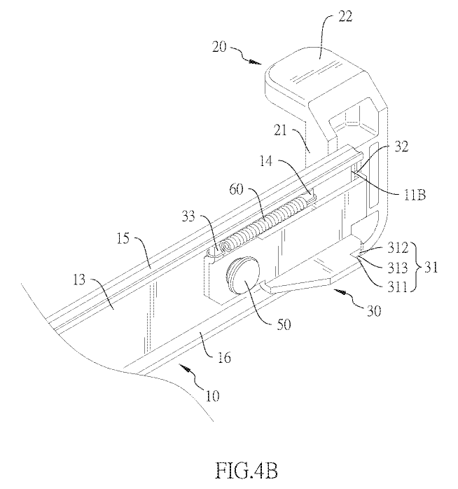

As shown in FIG. 3, the actuating portion 21 has a groove 211 formed therein, and the coupling portion 32 is formed by bending the clasp 30. The coupling portion 32 has a fixing piece 321, which is inserted into the groove 211 to fix the coupling portion 32. The fixing piece 321 is provided with a first hole 322, which cooperates with a second hole 212 provided on the actuating portion 21 and connected to the groove 211, and the first hole 322 corresponds to the second hole 212. A fitting 40 is passed through the first hole 322 to the second hole 212 to fix the fixing piece 321 to the groove 211. The fitting 40 can be a screw, a rivet, etc. In this embodiment, as shown in FIG. 4A, the first rail 10 is provided with an opening 11A, and the opening 11A corresponds to the actuating portion 21 and the coupling portion 32 respectively. The coupling portion 32 is connected to the actuating portion 21 via the opening 11A. In another embodiment, as shown in FIG. 4B, the first rail 10 has a front end 11B, the front end 11B is retracted and the coupling portion 32 is located in front of the front end 11B, so that the coupling portion 32 is connected to the actuating portion 21. However, the present invention is not limited thereto. It may further include a pivot member 50, the pivot member 50 being disposed between the clasp 30 and the first rail 10.

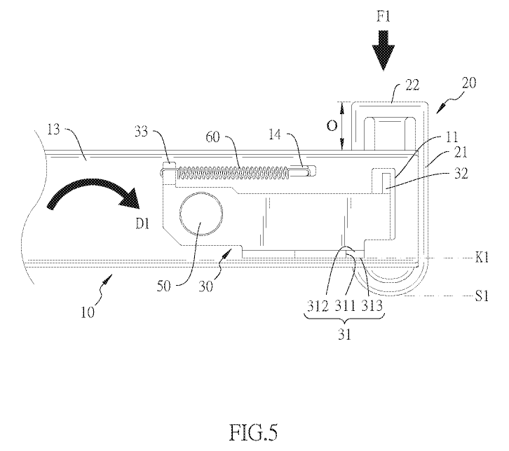

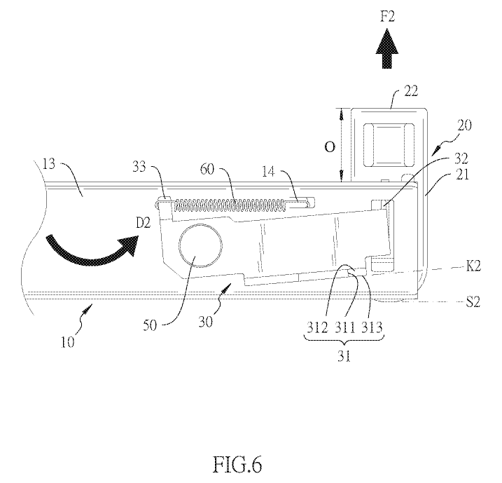

As shown in FIG. 5 and FIG. 6, when the actuating portion 21 is in a first state S1 and drives the clasp 30 toward a first position D1, the clasp portion 31 is in a locked state K1, or when the actuating portion 21 is in a second state S2 and drives the clasp 30 toward a second position D2, the clasp portion 31 is in an unlocked state K2. To further explain, the handle 20 has an operating portion 22 formed on the actuating portion 21. The operating portion 22 is positioned higher than the first rail 10. An operating stroke O is provided between the first rail 10 and the operating portion 22. When the operating stroke O changes due to a downward applied force F1 on the operating portion 22, the operating stroke O becomes shorter. Conversely, the actuating portion 21 in the first state S1 drives the clasp 30 toward the first position D1, placing the clasp portion 31 in the locked state K1. Alternatively, when the operating stroke O changes due to an operating force F2 on the operating portion 22, the operating stroke O becomes longer. Accordingly, the actuating portion 21 is in the second state S2 and drives the clasp 30 toward the second position D2, placing the clasp portion 31 in the unlocked state K2. With the height H1 of the operating portion 22 being less than the height H2 of the actuating portion 21 and the thickness T1 of the operating portion 22 being greater than the thickness T2 of the actuating portion 21, the operator can easily lock or unlock the operating portion 22, but is not limited thereto.

As described above, the first rail 10 has a fixing portion 14, the clasp 30 has a supporting portion 33 located above the clasp portion 31, and one end of an elastic member 60 is connected to the fixing portion 14, while the other end of the elastic member 60 is connected to the supporting portion 33. The elastic member 60 may be a spring. A first transverse wall 15 extends upward from the first surface 12 and the second surface 13, and a second transverse wall 16 extends downward from the first surface 12 and the second surface 13. The supporting portion 33 is relative to the first transverse wall 15, and the first transverse wall 15 forms a limit on the supporting portion 33. The clasp portion 31 is relative to the second transverse wall 16, and the second transverse wall 16 forms a limit on the clasp portion 31. However, the present invention is not limited thereto. In addition, the clasp 30 has a first pivot hole 34 and the first rail 10 has a second pivot hole 17, and a pivot member 50 is passed through the first pivot hole 34 to the second pivot hole 17.

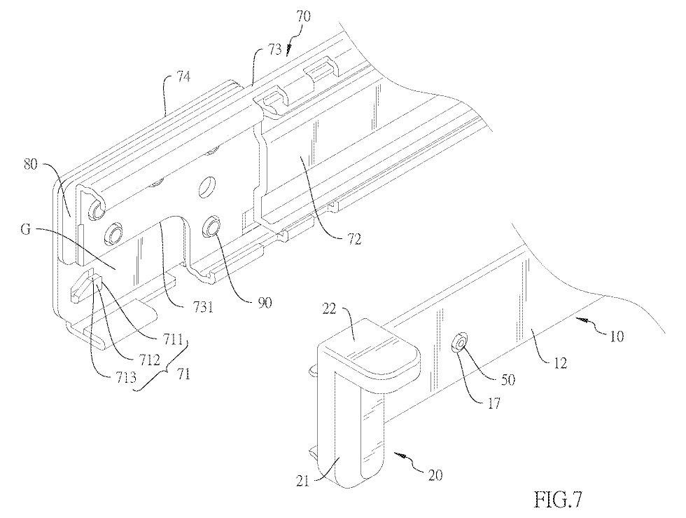

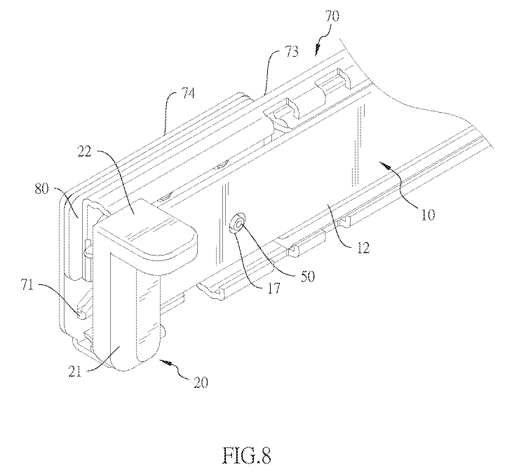

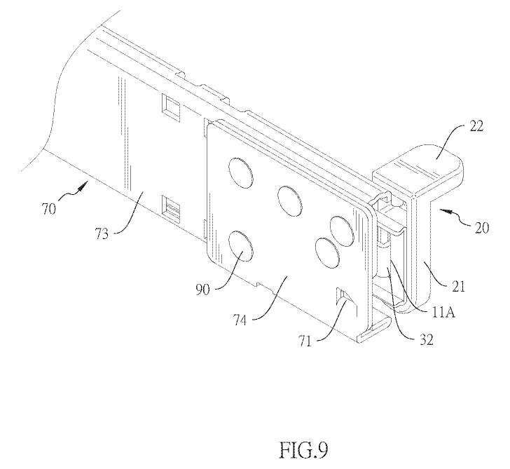

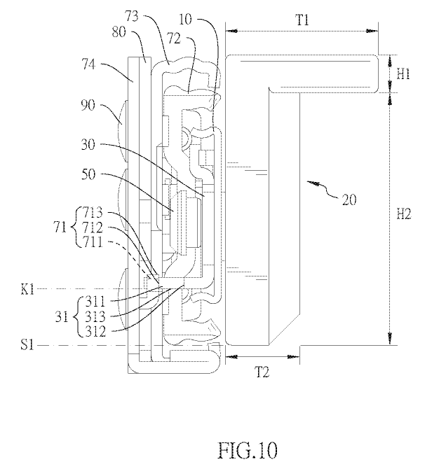

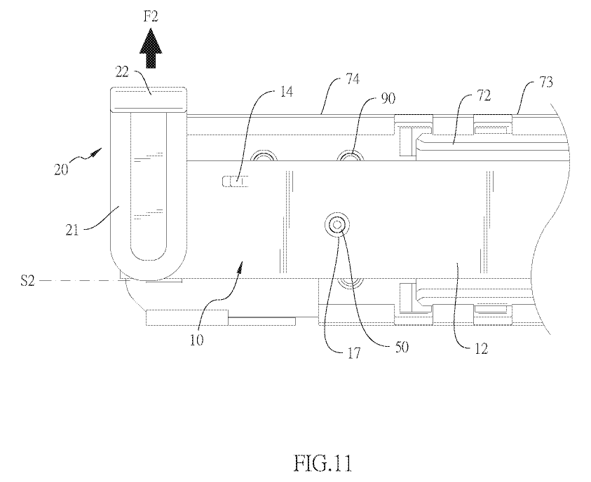

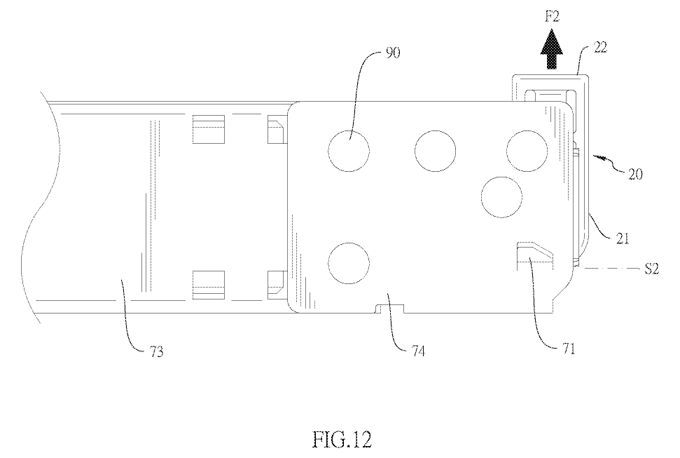

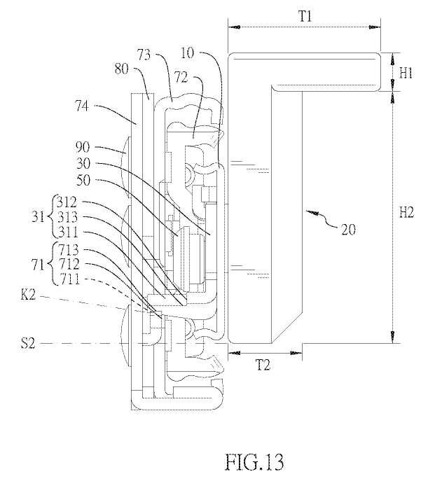

As shown in FIGS. 7, 8, 9, 10, 11, 12 and 13, a second rail 70 is provided. The second rail 70 has a buckle 71. When the actuating portion 21 is in the first state S1, it drives the clasp 30 toward the first position D1. The first position D1 is a horizontal position. The clasp portion 31 is buckled on the buckle 71 and enters the locked state K1. Alternatively, the actuating portion 21 in the second state S2 drives the clasp 30 toward the second position D2. The second position D2 is an angular position that causes the clasp portion 31 to separate from the buckle 71 and enter the unlocked state K2.

Continuing from above, the first rail 10 corresponds to the second rail 70. The second rail 70 comprises a middle frame 72, an outer frame 73 and a reinforcement frame 74. The middle frame 72 is moved relative to the outer frame 73 and the reinforcement frame 74 is fixed to the outer frame 73, and the reinforcement frame 74 and the outer frame 73 can also be integrally formed. To further illustrate, the first rail 10 may be an inner frame, the inner frame being moved relative to the middle frame 72, and the buckle 71 being located on the reinforcement frame 74. The reinforcement frame 74 is independently adjusted in position on the outer frame 73, and also adjusts the amount of interference between the buckle 71 and the clasp portion 31. In particular, the buckle 71 is positioned on the reinforcement frame 74 to increase the amount of interference between the buckle 71 and the clasp portion 31, thereby preventing the problem of fastening failure. The outer frame 73 is provided with a recess 731 corresponding to the buckle 71 and the clasp portion 31. The recess 731 forms an active space G, and the buckle 71 and the clasp portion 31 enter the locked state K1 or the unlocked state K2 in the active space. It may further include a buffer member 80, the buffer member 80 is disposed between the reinforcement frame 74 and the outer frame 73, and can also adjust the amount of interference between the buckle 71 and the clasp portion 31. And a fixing member 90 passes through the reinforcement frame 74, the buffer member 80 and is fixed to the outer frame 73, but is not limited thereto.

As mentioned above, the clasp portion 31 has a first buckle surface 311 and a first abutment surface 312 formed on the side of the first buckle surface 311, and the buckle 71 has a second buckle surface 711 and a second abutment surface 712 formed on the side of the second buckle surface 711. The first buckle surface 311 is opposite to the second buckle surface 711 and the first abutment surface 312 is opposite to the second abutment surface 712, so that the clasp portion 31 and the buckle 71 can define the relative position of interference with each other, and can also ensure the locked state K1 or the unlocked state K2. The buckle 71 has a guide surface 713 and the clasp portion 31 has a bottom surface 313. The bottom surface 313 is opposite to the guide surface 713, and the guide surface 713 guides the bottom surface 313 to move. The guide surface 713 is on one lateral side of the second buckle surface 711, and the bottom surface 313 is on the lower side of the first buckle surface 311 and the first abutment surface 312. In the locked state K1, the bottom surface 313 is guided along one side of the guide surface 713, and then the second buckle surface 711 moves downward to contact the first buckle surface 311, and the second abutment surface 712 moves downward to contact the first abutment surface 312. Alternatively, in the unlocked state K2, the second buckle surface 711 moves upward and away from the first buckle surface 311, and the second abutment surface 712 moves upward and away from the first abutment surface 312, and then the bottom surface 313 is guided along the other side of the guide surface 713, but the present invention is not limited thereto.

What is claimed:

1. A slide rail assembly, comprising:
a first rail comprising a first surface and a second surface opposite to said first surface;
a handle disposed on said first surface, said handle comprising an actuating portion; and
a clasp provided on said second surface, said clasp comprising a clasp portion and a coupling portion opposite to said clasp portion, said coupling portion being connected to said actuating portion, said actuating portion being switchable between a first state and a second state, so that when said actuating portion is in said first state, said clasp is driven toward a first position, or when said actuating portion is in said second state, the clasp is driven toward a second position.

2. The slide rail assembly as claimed in claim 1, further comprising a second rail, said second rail comprising a buckle, wherein when said actuating portion is in said first state and drives said clasp toward said first position, said clasp portion is locked on said buckle and enters a locked state; alternatively, when said actuating portion is in said second state and drives said clasp toward said second position, said clasp portion is detached from said buckle and enters an unlocked state.

3. The slide rail assembly as claimed in claim 2, wherein said clasp portion comprises a first buckle surface and a first abutment surface formed on one side of said first buckle surface, and said buckle comprises a second buckle surface and a second abutment surface formed on one side of said second buckle surface, and said first buckle surface is relative to said second buckle surface and said first abutment surface is relative to said second abutment surface.

4. The slide rail assembly as claimed in claim 2, wherein said buckle comprises a guide surface and said clasp portion comprises a bottom surface, said bottom surface being opposite to said guide surface, and said guide surface guiding said bottom surface to perform a movement.

5. The slide rail assembly as claimed in claim 2, wherein said first rail is opposite to said second rail; said second rail comprises a middle frame, an outer frame and a reinforcement frame, said middle frame being moved relative to said outer frame, said reinforcement frame being fixed to said outer frame; said buckle is located on said reinforcement frame.

6. The slide rail assembly as claimed in claim 5, wherein said outer frame comprises a recess corresponding to said buckle and said clasp portion, said recess forming an active space, allowing said buckle and said clasp portion to enter said locked state or said unlocked state in said active space.

7. The slide rail assembly as claimed in claim 5, further comprising a buffer member, said buffer member being disposed between said reinforcement frame and said outer frame and being fixed to said outer frame by a fixing member passing through said reinforcement frame and said buffer member.

8. The slide rail assembly as claimed in claim 5, wherein said first rail is an inner frame, said inner frame being moved relative to said middle frame.

9. The slide rail assembly as claimed in claim 1, wherein said first rail comprises an opening corresponding to said actuating portion and said coupling portion, respectively, and said coupling portion is connected to said actuating portion via said opening.

10. The slide rail assembly as claimed in claim 1, wherein said first rail comprises a front end that is retracted and said coupling portion is located in a front side of said front end, so that said coupling portion is connected to said actuating portion.

11. The slide rail assembly as claimed in claim 1, wherein said actuating portion is provided with a groove; said coupling portion is formed by bending said clasp, and is provided with a fixing piece, which is inserted into said groove for fixation.

12. The slide rail assembly as claimed in claim 11, wherein said fixing piece is provided with a first hole, and said actuating portion is provided with a second hole that is connected to said groove, and said first hole corresponds to said second hole, for allowing a fitting to pass through said first hole to said second hole to fix said fixing piece to said groove.

13. The slide rail assembly as claimed in claim 1, wherein said handle comprises an operating portion formed on said actuating portion, and said operating portion is positioned higher than said first rail.

14. The slide rail assembly as claimed in claim 13, wherein the height of said operating portion is smaller than the height of said actuating portion and the thickness of said operating portion is greater than the thickness of said actuating portion.

15. The slide rail assembly as claimed in claim 13, wherein an operating stroke is provided between said first rail and said operating portion; when said operating portion is subjected to a downward applied force to change said operating stroke, said actuating portion is in said first state and drives said clasp toward said first position, or when said operating portion is subjected to an operating force to change operating stroke, said actuating portion is in said second state and drives said clasp toward said second position.

16. The slide rail assembly as claimed in claim 15, wherein said first position is a horizontal position and said second position is an angular position.

17. The slide rail assembly as claimed in claim 1, wherein said first rail comprises a fixing portion, said clasp comprises a supporting portion located above said clasp portion, and fixing portion and said supporting portion being connected with an elastic member therebetween.

18. The slide rail assembly as claimed in claim 1, wherein said clasp comprises a supporting portion located above said clasp portion; said first surface and said second surface extend upwards to form a first transverse wall, and said first surface and said second surface extend downwards to form a second transverse wall; said supporting portion is opposite to said first transverse wall, and said clasp portion is opposite to said second transverse wall.

19. The slide rail assembly as claimed in claim 1, further comprising a pivot member mounted in said clasp and said first rail.

20. The slide rail assembly as claimed in claim 19, wherein said clasp is provided with a first pivot hole and said first rail is provided with a second pivot hole, and said pivot member is passed through said first pivot hole to said second pivot hole.
